(19) United States
(12) Patent Application Publication
(10) Pub. No.: US 2024/0053717 A1
(43) Pub. Date: Feb. 15, 2024

(54) MODULAR CONTROL APPARATUS

(71) Applicant: Pilz GmbH & Co. KG, Ostfildern (DE)

(72) Inventors: Jochen Bauknecht, Ostfildern (DE); Hansjürgen Horter, Ostfildern (DE)

(21) Appl. No.: 18/361,520

(22) Filed: Jul. 28, 2023

(30) Foreign Application Priority Data
Aug. 10, 2022 (DE) 10 2022 120 198.8

(51) Int. Cl. G05B 19/042

(52) U.S. Cl. CPC G05B 19/0423; G05B 19/0428; G05B 2219/23208

(57) ABSTRACT

A modular control apparatus comprises a central control module with a first logic unit and a second logic unit, first electronic modules connected to the first logic unit and having safety inputs and safety outputs, wherein the first electronic modules are designed to provide safety functions of a safety controller, and second electronic modules connected to the second logic unit and having inputs and outputs, wherein the second electronic modules are designed to provide standard functions of a programmable logic controller. The central control module and the first and second electronic modules are arranged in a row of modules. The safety functions of the first electronic modules are defined by positions of the first electronic modules in the row of modules and/or by fixed hardware settings, and the standard functions of the second electronic modules are programmable.

### CROSS REFERENCE TO RELATED APPLICATIONS

This application claims priority under 35 U.S.C. § 119(a)-(d) to German application No. 10 2022 120 198.8 filed on Aug. 10, 2022, the entire contents of which are hereby incorporated by reference.

### TECHNICAL FIELD

The present disclosure relates to a modular control apparatus.

### BACKGROUND

Different types of control apparatuses are known from the prior art that may have different ranges of functions. A distinction must be made here between programmable logic controllers, according to the European standard EN 61131, on the one hand, and safety controllers, according to the international standard IEC 61508, on the other hand. Both types of controllers provide additional safety functions and, hence, can also be used in safety-critical areas to control safety-critical processes automatically.

In principle, it is also known from the prior art to design both programmable logic controllers and safety controllers modularly from a plurality of electronic modules that provide a variety of functions.

A modular programmable logic controller comprises a logic unit and, connected thereto, several electronic modules, which provide a number of inputs and a number of outputs. Sensors may be connected to the inputs in the conventional manner. The sensors can deliver, for example, information about an operating status of a machine or technical system to be controlled and can provide the information as the input signals of the programmable logic controller. These input signals can be evaluated with the help of the logic unit; and, as a result thereof, corresponding output signals are generated by logical links and optionally other signal and data processing steps. The output signals are emitted via the outputs of the electronic modules. Connected to the outputs are actuators, which can process the output signals and, thereupon, can perform certain actions.

Modular safety controllers serve, in particular, the purpose of bringing technical systems or machines safely into a non-hazardous state for humans in the event of a hazardous situation. For this purpose corresponding input signals of signal transmitters or signaling devices, which may be, for example, emergency OFF switches, emergency STOP switches, light grids, light barriers, pressure sensitive safety shutdown mats, safety door position switches, 3D laser scanners, etc., are received by a number of safety inputs and are evaluated reliably by a logic unit on the input side. On the output side, corresponding safety outputs of an output circuit are actuated. In the event of a hazardous situation actuators, such as, for example, contactors, valves, etc., are actuated with output signals via the safety outputs such that the machine(s) or technical system, which is/are connected to the actuators, can be brought into a non-hazardous state for humans.

Such modular safety controllers comprise several electronic modules that are arranged in at least one row of modules and have certain functionalities. The modular design of a safety controller offers in an advantageous way the possibility of an application specific configuration in which several electronic modules are individually arranged, wired together and configured such that they can provide the desired safety functions. Examples of electronic modules from which modular safety controllers with a wide variety of different safety functions can be designed are, inter alia, input modules, which can receive and, if necessary, can process, for example, input signals of one or more signal transmitters, such as, for example, input signals of sensors or emergency command devices; output modules, which can emit output signals to one or more actuators connected to the output modules; combined input and output modules (so-called I/O modules); control modules, which can control the matching of input modules to output modules; as well as interface modules; communications modules; fieldbus controllers; fieldbus couplers; etc. In the course of manufacturing the modular safety controller the electronic modules are lined up beside each other in the at least one row of modules and correspondingly wired together and configured such that the electronic modules can provide the functionalities required for the specific use, for which they were intended in terms of the safety aspects.

In order to provide the tasks of a safety controller and a programmable logic controller, two devices are required, an approach that results in the need for a large amount of space, a high degree of installation and wiring complexity, and the need for a large number of relay contacts.

### SUMMARY

An object of the described system is to provide a modular control apparatus that has an expanded range of functions.

A modular control apparatus described herein comprises:
a central control module with a first logic unit and a second logic unit;
a first group of electronic modules, which are connected to the first logic unit and comprise a number of safety inputs and safety outputs, wherein the electronic modules of the first group are designed to provide the safety functions of a safety controller; and
a second group of electronic modules, which are connected to the second logic unit and comprise a number of inputs and outputs, wherein the electronic modules of the second group are designed to provide the standard functions of a programmable logic controller, wherein:
the central control module and the two groups of electronic modules are arranged in at least one row of modules;
the safety functions of the electronic modules of the first group are defined by the positions of the electronic modules in the row of modules and/or by the fixed hardware settings; and
the standard functions of the electronic modules of the second group are programmable.

The disclosed modular control apparatus has the advantage that the functions of a safety controller, in particular, the safe shutdown, and a programmable logic controller can be provided together in a single device. As a result, there are space and cost advantages. The safety functions of the modular control apparatus, where the safety functions are provided with the help of the first group of electronic modules, cannot be modified on the software side, but rather are permanently set or, more specifically, predetermined by the order of modules. In contrast, the functions of the electronic modules of the second group, the functions being the standard functions of a programmable logic controller, are freely programmable. A corresponding programming tool can be used to program the second logic unit and, hence, also the standard functions of the electronic modules of the second group. The programming tool may be executed, for example, by a computer or app-based by a tablet PC or a smartphone. The programming tool can also be designed to be cloud-based.

Due to the fact that the permanent setting of the safety functions of the electronic modules of the first group cannot be changed by the installer, because the safety functions cannot be modified by the programming tool, the installer of the modular control apparatus cannot make a safety-critical mistake with respect to the safety functions, since he can only program the standard functions of the programmable logic controller. As a result of the fixed (and, therefore, non-modifiable by the user) setting of the safety functions of the electronic modules of the first group, the approval process performed by the testing authorities is also simplified. Changing the standard functions by reprogramming the electronic modules of the second group and/or exchanging one or more electronic modules of the second group is/are possible without there being any need for a new safety approval or safety review of the modular control apparatus, since the safety functions of the modular control apparatus are not changed or adversely affected by these measures.

In order to simplify the startup procedure of the modular control apparatus, there is the possibility in an advantageous embodiment that the first logic unit is designed to detect automatically the positions of the electronic modules of the first group in the row of modules and/or the fixed hardware settings of the electronic modules of the first group.

Preferably, the permanent hardware settings of the electronic modules of the first group may comprise fixed settings of potentiometers and/or switches, in particular, DIP switches, of the electronic modules of the first group. The fixed settings of potentiometers and/or switches, in particular, DIP switches, of the electronic modules of the first group can be done very easily by the manufacturer.

In a preferred embodiment, it is proposed that the second logic unit be designed to receive and to process data from the first logic unit and/or input signals of the electronic modules of the first group.

In a particularly preferred embodiment, there is the possibility that the central control module has a bidirectional communications interface, in particular, a data bus, between the two logic units.

In an advantageous further development, it can be provided that the second logic unit is designed to generate switch-off signals for the safety outputs of the electronic modules of the first group.

In one embodiment it can be provided that the second logic unit is designed to generate disable signals for the safety outputs of the electronic modules of the first group. This feature can prevent switch-on signals from being emitted via the safety outputs of the electronic modules of the first group.

In order to raise the safety level that can be reached by the modular control apparatus, it is proposed in one advantageous embodiment that the first logic unit be designed to be redundant.

It is not necessary for a modular control apparatus to exhibit all of the features described below to fall within the scope of the described system. It is also possible for a modular control apparatus to exhibit only individual features of the example embodiment described below.

### BRIEF DESCRIPTION OF THE DRAWINGS

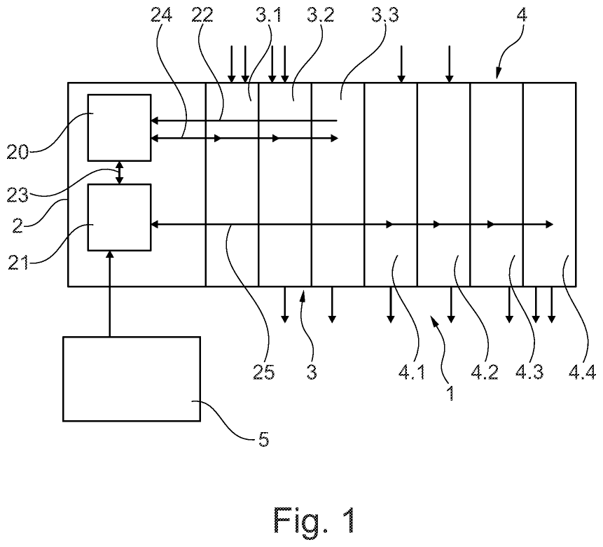

Other features and advantages of an example embodiment of the described system are described below with reference to FIG. 1, which shows a modular safety control apparatus in a highly simplified schematic form.

### DETAILED DESCRIPTION

As shown in FIG. 1, a modular control apparatus 1 comprises a central control module 2, which is also often referred to as a head module; a first group 3 of electronic modules 3.1, 3.2, 3.3; and a second group 4 of electronic modules 4.1, 4.2, 4.3, 4.4. The two groups 3, 4 of electronic modules 3.1, 3.2, 3.3 and 4.1, 4.2, 4.3, 4.4 are arranged together with the central control module 2 in a row of modules. The central control module 2 comprises a first logic unit 20, which is assigned at least to the first group 3 of electronic modules 3.1, 3.2, 3.3, and a second logic unit 21, which is assigned at least to the second group 4 of electronic modules 4.1, 4.2, 4.3, 4.4. The two logic units 20, 21 are in communication with each other via a bidirectional communications interface 23, in particular, via a data bus, so that a data exchange between the two logic units 20, 21 can take place while the modular control apparatus 1 is in operation. Preferably, the first logic unit 20 can be designed to be redundant, in order to enhance the fail-safe performance. This redundancy of the first logic unit 20 is illustrated by a diagonal line in FIG. 1.

The electronic modules 3.1, 3.2, 3.3 of the first group 3 and the first logic unit 20 form a safety function part of the modular control apparatus 1; and the electronic modules 4.1, 4.2, 4.3, 4.4 of the second group 4 as well as the second logic unit 21 form a standard function part of the modular control apparatus 1.

In this case, the electronic modules 3.1, 3.2, 3.3 of the first group 3 are selected from a plurality of different types of electronic modules that are designed to provide the functions of a safety controller, according to the international standard IEC 61508. The electronic modules 3.1, 3.2, 3.3 of the first group 3 may be, for example, the following types of electronic modules:
input modules with one or more safety inputs, via which the input signals of one or more signal transmitters, such as, for example, input signals of sensors or emergency command devices, can be reliably received;
output modules with one or more safety outputs, via which the output signals, in particular, switch-on signals and switch-off signals, can be reliably emitted to one or more actuators, connected to the safety outputs;
combined input and output modules (so-called I/O modules), which comprise safety inputs and safety outputs; and
interface modules; fieldbus controllers; fieldbus couplers; etc. This list of the types of electronic modules is not to be understood as exhaustive.

The safety inputs and the safety outputs of the electronic modules 3.1, 3.2, 3.3 of the first group 3 are symbolized by the corresponding arrows in FIG. 1.

The first logic unit 20 is in communication with the electronic modules 3.1, 3.2, 3.3 of the first group 3 via a bidirectional communications interface 24, in particular, via a data bus, so that a data exchange between the first logic unit 20 and the electronic modules 3.1, 3.2, 3.3 of the first group 3 can take place while the modular control apparatus 1 is in operation.

The number and type of the electronic modules 3.1, 3.2, 3.3 that are used depends directly on the intended use and application of the modular control apparatus 1 and also on the safety level to be reached by the electronic modules 3.1, 3.2, 3.3 of the first group 3. In general, the task of the electronic modules 3.1, 3.2, 3.3 of the first group 3 is to switch off in a safety-oriented manner the actuators, connected to the safety outputs of the electronic modules 3.1, 3.2, 3.3 of the first group 3, in the event of a hazardous situation, which is detected by the sensors and/or signaling devices, and also to switch on again after the end of the hazardous situation.

The safety functions of the electronic modules 3.1, 3.2, 3.3 of the first group 3 are defined only by the order of sequence, in which the electronic modules 3.1, 3.2, 3.3 of the first group 3 are arranged in the row of modules, and/or by the hardware settings, such as, for example, by certain (fixed) turn positions of potentiometers and/or by certain (fixed) settings of switches, in particular, DIP switches. In other words, the safety functions of the modular control apparatus 1 cannot be changed on the software side, but rather are permanently set.

The first logic unit 20 is designed preferably to read out and process automatically the order of sequence, in which the electronic modules 3.1, 3.2, 3.3 of the first group 3 are arranged in the row of modules, and/or the hardware settings of the electronic modules 3.1, 3.2, 3.3 of the first group 3, in particular, the fixed turn positions of potentiometers and/or the fixed settings of switches of the electronic modules 3.1, 3.2, 3.3 of the first group 3. This is symbolized by the arrow 22 in FIG. 1.

The electronic modules 4.1, 4.2, 4.3, 4.4 of the second group 4 are selected from a plurality of different types of electronic modules that are designed to provide the functions of a programmable logic controller, according to the European standard EN 61131. The second logic unit 21 is in communication with the electronic modules 4.1, 4.2, 4.3, 4.4 of the second group 4 via a bidirectional communications interface 25, in particular, via a data bus, so that a data exchange between the second logic unit 21 and the electronic modules 4.1, 4.2, 4.3, 4.4 of the second group 4 can take place while the modular control apparatus 1 is in operation. The electronic modules 4.1, 4.2, 4.3, 4.4 of the second group 4 may have one or more inputs and/or one or more outputs in a manner known per se. The inputs and the outputs of the electronic modules 4.1, 4.2, 4.3, 4.4 of the second group 4 are also symbolized by corresponding arrows in FIG. 1.

In particular, sensors may be connected to the inputs of the electronic modules 4.1, 4.2, 4.3, 4.4 of the second group 4. The sensors may deliver, for example, information about an operating status of a machine or a technical system and can provide the information as the input signals of the second logic unit 21. These input signals are evaluated with the help of the second logic unit 21; and, in so doing, output signals are generated by logical links and optionally other signal and data processing steps. The output signals are emitted via the outputs of the electronic modules 4.1, 4.2, 4.3, 4.4 of the second group 4. Connected to these outputs are actuators, which can process the output signals and, thereupon, can perform certain actions.

In contrast to the safety functions of the electronic modules 3.1, 3.2, 3.3 of the first group 3, the functions of the electronic modules 4.1, 4.2, 4.3, 4.4 of the second group 4, the functions being the standard functions of a programmable logic controller, are freely programmable. A corresponding programming tool 5 can be used to program the second logic unit 21 and, hence, also the functions of the electronic modules 4.1, 4.2, 4.3, 4.4 of the second group 4. The programming tool 5 may be executed, for example, by a computer or app-based by a tablet PC or a smartphone. The programming tool 5 can also be designed to be cloud-based.

Preferably, the two logic units 20, 21 can be configured such that all data of the safety function part of the modular safety switching apparatus 1, such as, for example, the input data of the safety inputs of the electronic modules 3.1, 3.2, 3.3 of the first group 3, can also be used as the input signals in the standard function part of the modular safety switching apparatus 1 and can be received and processed by the second logic unit 21.

Furthermore, the logic units 20, 21 can be configured preferably such that the second logic unit 21 can also actuate the safety outputs of the electronic modules 3.1, 3.2, 3.3 of the first group 3. However, the second logic unit can only disable the safety outputs or, more specifically, can only switch off the enabling thereof and cannot switch on when the safety function is not enabled. In this case it involves a so-called “enable” principle.

A crucial advantage of the modular control apparatus 1, described here, lies in the fact that the functions of a safety controller and a programmable logic controller are provided together in a single device. Such an approach results, in particular, in space and cost advantages. Furthermore, the safety outputs of the electronic modules 3.1, 3.2, 3.3 of the first group 3, where the electronic modules provide the safety functions of the modular control apparatus 1, can also be used in an advantageous way for process control, so that relay contacts can be dispensed with.

Owing to the permanent setting of the safety functions of the electronic modules 3.1, 3.2, 3.3 of the first group 3, where the safety functions cannot be modified by the programming tool 5, the installer cannot make a safety-critical mistake with respect to the safety functions, since he can only program the standard functions of the programmable logic controller and cannot access the safety functions that are implemented on the hardware side.

As a result of the fixed (and, therefore, non-modifiable by the user) setting of the safety functions of the electronic modules 3.1, 3.2, 3.3 of the first group 3, the approval process performed by the testing authorities is also simplified. Changing the standard functions by reprogramming the electronic modules 4.1, 4.2, 4.3, 4.4 of the second group and/or exchanging one or more electronic modules 4.1, 4.2, 4.3, 4.4 of the second group 4 is/are possible without there being any need for a new safety approval or safety review of the modular control apparatus 1.

In the event that the device, on which the programming tool is executed, were to have safety problems, these safety problems will not advantageously result in safety problems of the modular control apparatus 1, since it is not possible to access the safety functions of the electronic modules 3.1, 3.2, 3.3 of the first group 3 by the programming tool. Thus, the configuration of the safety functions of the electronic modules 3.1, 3.2, 3.3 of the first group 3 is maximally conservative, since only hardware settings are possible, whereas the software-based configuration of the standard functions of the electronic modules 4.1, 4.2, 4.3, 4.4 of the second group 4 can be done very flexibly and open.

What is claimed is:

1. A modular control apparatus, comprising:
a central control module with a first logic unit and a second logic unit;
first electronic modules connected to the first logic unit and having safety inputs and safety outputs, wherein the first electronic modules are designed to provide safety functions of a safety controller; and
second electronic modules connected to the second logic unit and having inputs and outputs, wherein the second electronic modules are designed to provide standard functions of a programmable logic controller, wherein:
the central control module and the first and second electronic modules are arranged in a row of modules;
the safety functions of the first electronic modules are defined by positions of the first electronic modules in the row of modules and/or by fixed hardware settings; and
the standard functions of the second electronic modules are programmable.

2. The modular control apparatus of claim 1, wherein the first logic unit is designed to detect automatically the positions of the first electronic modules in the row of modules and/or the fixed hardware settings of the first electronic modules.

3. The modular control apparatus of claim 1, wherein the fixed hardware settings of the first electronic modules comprise fixed settings of potentiometers and/or switches of the first electronic modules.

4. The modular control apparatus of claim 3, wherein the switches are DIP switches.

5. The modular control apparatus of claim 1, wherein the second logic unit is designed to receive and to process data from the first logic unit and/or input signals of the first electronic modules.

6. The modular control apparatus of claim 1, wherein the central control module has a bidirectional communications interface between the first and second logic units.

7. The modular control apparatus of claim 6, wherein the bidirectional communications interface is a data bus.

8. The modular control apparatus of claim 1, wherein the second logic unit is designed to generate switch-off signals for the safety outputs of the first electronic modules.

9. The modular control apparatus of claim 1, wherein the second logic unit is designed to generate disable signals for the safety outputs of the first electronic modules.

10. The modular control apparatus of claim 1, wherein the first logic unit is designed to be redundant.
